(19) United States
(12) Patent Application Publication
(10) Pub. No.: US 2021/0034676 A1
(43) Pub. Date: Feb. 4, 2021

(54) SEMANTIC RELATIONSHIP SEARCH AGAINST CORPUS

(71) Applicant: INTERNATIONAL BUSINESS MACHINES CORPORATION, Armonk, NY (US)

(72) Inventors: Scott Carrier, Apex, NC (US); Brendan Bull, Durham, NC (US); Dwi Sianto Mansjur, Cary, NC (US); Paul Lewis Felt, Springville, UT (US)

(21) Appl. No.: 16/525,997

(22) Filed: Jul. 30, 2019

(51) Int. Cl. G06F 16/9038; G06F 17/27

(52) U.S. Cl. CPC G06F 16/9038; G06F 17/277; G06F 17/2785

(57) ABSTRACT

Methods, systems, and computer program products for semantic search are provided. Aspects include receiving a query, the query comprising one or more search concepts, determining a semantic type from a plurality of semantic types for each of the one or more search concepts, analyzing the one or more search concepts to determine one or more relationships associated with the one or more search concepts, and determining one or more search results from a corpus based at least in part on the one or more relationships and the one or more search concepts.

### BACKGROUND

The present invention generally relates to semantic searching, and more specifically, to semantic relationship searching against a corpus where a relationship does not exist.

Search engines or search algorithms are information retrieval systems that are typically designed to help find information in a searchable dataspace (e.g., a database, the world wide web). These search engines provide an interface for a user to specify criteria about an item of interest for the search engine to find matching items in the searchable dataspace. These search engines, typically, look to identify matching terminology or similar terminology of the search query when determining the results of the search. However, the intent of the user performing the search is not taken into account when performing the search. Search engines, often, do not formulate a relationship query where there is some semantic interaction between two concepts. Relationships of the concepts can assist with searching through certain types of dataspaces such as a medical corpus. A relationship between concepts like medications and how they relate to certain conditions can be of interest to users that are searching these medical corpora.

### SUMMARY

Embodiments of the present invention are directed to a computer-implemented method for semantic searching. A non-limiting example of the computer-implemented method includes receiving a query, the query comprising one or more search concepts, determining a semantic type from a plurality of semantic types for each of the one or more search concepts, analyzing the one or more search concepts to determine one or more relationships associated with the one or more search concepts, and determining one or more search results from a corpus based at least in part on the one or more relationships and the one or more search concepts.

Embodiments of the present invention are directed to a system for semantic searching. A non-limiting example of the system includes a processor configured to perform receiving a query, the query comprising one or more search concepts, determining a semantic type from a plurality of semantic types for each of the one or more search concepts, analyzing the one or more search concepts to determine one or more relationships associated with the one or more search concepts, and determining one or more search results from a corpus based at least in part on the one or more relationships and the one or more search concepts.

Embodiments of the invention are directed to a computer program product for semantic searching, the computer program product comprising a computer readable storage medium having program instructions embodied therewith. The program instructions are executable by a processor to cause the processor to perform a method. A non-limiting example of the method includes receiving a query, the query comprising one or more search concepts, determining a semantic type from a plurality of semantic types for each of the one or more search concepts, analyzing the one or more search concepts to determine one or more relationships associated with the one or more search concepts, and determining one or more search results from a corpus based at least in part on the one or more relationships and the one or more search concepts.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for semantic searching according to one or more embodiments of the invention;

FIG. 5 depicts an exemplary parse tree for the example passage from a document according to one or more embodiments;

FIG. 6 depicts an exemplary parse tree for the example new passage from a document according to one or more embodiments; and

FIG. 7 depicts a flow diagram of a method for semantic searching according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure that includes a network of interconnected nodes.

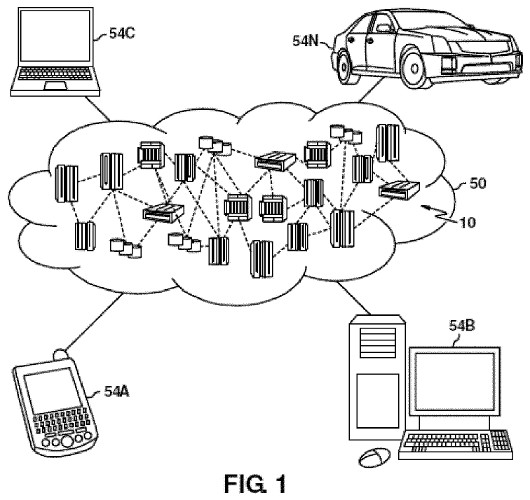

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

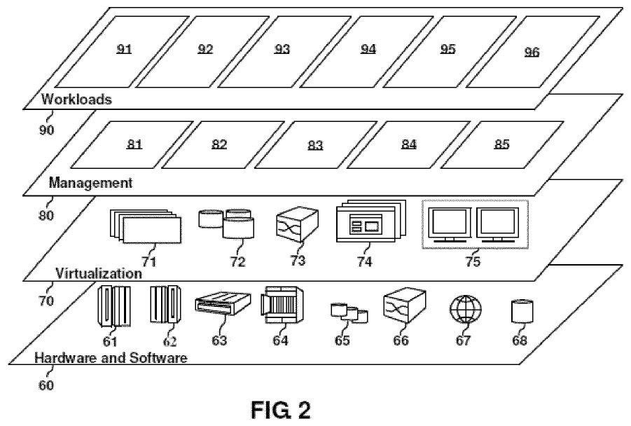

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and semantic searching against a corpus where relationship annotations do not exist 96.

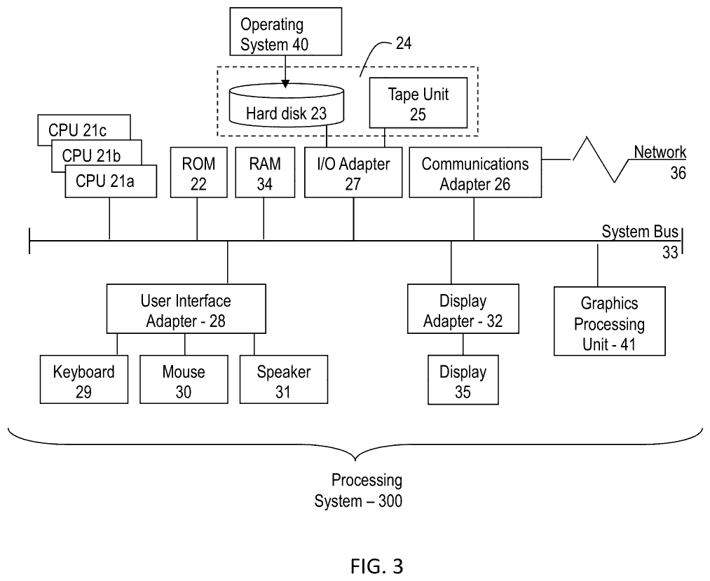

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

Turning now to an overview of technologies that are more specifically relevant to aspects of the invention, a semantic search is a search type that utilizes a determined meaning of search entities or concepts in a semantic search query. This search type is distinguished from a lexical search where a search engine or algorithm looks for literal matches of the values included in the query. A semantic search attempts to improve searching accuracy by determining an intent of the searcher as well as a contextual meaning of the terms in the query as they may appear in the searchable dataspace. However, for semantic search algorithms, it can be a challenge to predict the relationships that a user of the semantic search algorithm might desire to search. Typically, relation searches can be utilized to determine these relationships. However, relation annotations are needed in the searchable dataspace (corpus) to yield proper results. A need exists to allow a user to search in a semantic search application without the need for the exact relation annotations to exist in the searchable corpus.

Turning now to an overview of the aspects of the invention, one or more embodiments of the invention address the above-described shortcomings of the prior art by providing a semantic search application that can determine and predict the relationships a user of the semantic search application might desire to search without the need for relation annotations in the searchable corpus. The above-described aspects of the invention address the shortcomings of the prior art by providing an engine for a semantic search application that can identify a relation within a semantic search query and utilize the relation text in the query along with associated concepts to perform a relation query against a corpus that has not previously been annotated with these relationships.

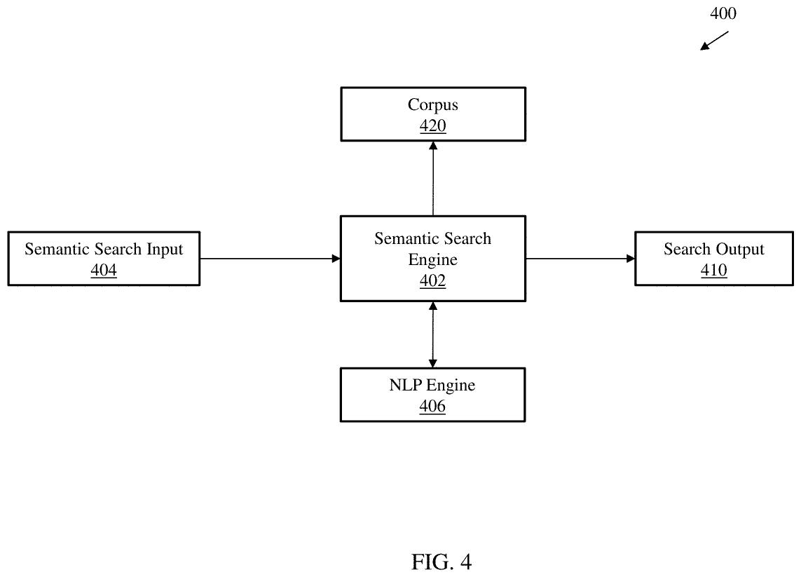

Turning now to a more detailed description of aspects of the present invention, FIG. 4 depicts a system for semantic searching according to embodiments of the invention. The system 400 includes a semantic search engine 402, a semantic search input 404, a natural language processing (NLP) engine 406, and a search output 410. The system 400 also includes a searchable corpus 420. The system 400 allows for a user to input a semantic search query into the semantic search input 404.

In one or more embodiments of the invention, the semantic search engine 402 can be utilized when the corpus 420 includes one or more medical resources (e.g., texts, research papers, drug manufacturer literature, patient charts, etc.). These medical resources may have different indexing and structure when performing the search causing difficulty in determining relationships between concepts and terms across the multiple resources. A keyword/phrase based search approach would need the search to be encoded in a way that is likely to appear in the corpus. For example, searching for symptoms for a medical condition would need to be described in the same terminology used in the corpus. The term “broken leg” may need to be reworded to include terms such as “fractured tibia” to likely find the associated location for this condition in the medical corpus. When searching for medications, the keyword/phrase based approach would require that the searcher query a specific medication name rather than a broad class of medications. (e.g., XYZ medication vs. blood pressure medication).

For a user conducting a semantic search for a specific association between two medical entities using natural language, the semantic search engine 402 can identify the relation between the medical entities to complete a search. For example, consider the following semantic search query:

“Medication treats COPD.”

The semantic search engine 402 and NLP engine 406 could determine the following from this semantic search query:

[?Medication(sem type)?] treats (NL relation)[COPD(specific condition concept)].

In one or more embodiments of the invention, the corpus 420 includes defined entities in the text of the corpus. These defined entities are essentially labeled entities or concepts that have been defined to indicate information associated with the concept or entity such as, for example, semantic type, specific condition concept, and the like. For a medical corpus, the corpus 420 can be annotated with medications and condition concept mentions, but there are no relationship annotations in the corpus 420 linking medications with the conditions that the medications treat. An initial search is performed for the medications and conditions that coexist within a natural language query. As shown in the semantic search query, the medication type is a semantic type (sematype) with COPD being a sematype for a medical condition. The sentence in the semantic search query is tokenized and a token distance between concepts within the relationship is then determined. In some embodiments of the invention, some co-occurring concept instances can be dropped should the token distance exceed a configurable threshold. The sentence (semantic search query) can be iterated utilizing a parse tree to determine when any semantic association exists between the two medical entities. Sentences that lack a semantic association can be discarded. With the remaining sentences, semantic roles mechanisms such as utilizing parser rules or machine learning, can be utilized to extract the relationship between two entities or concepts. If there is a word or phrase discovered that describes the relationship between two entities or concepts, this word or phrase can be compared to the query relationship by a distance metric (e.g., word embedding distances or a thesaurus lookup mechanism). For example, the system 400 does not confuse a “treats” relationship with a “causes” relationship; however, the system 400 can identify words like “alleviated” (e.g., x alleviates headache). Associations that are beyond a configurable distance threshold can be discarded and associations deemed valid (i.e., within the configuration distance threshold) can be returned.

Let's look at a this example in more detail. Suppose the user searches for “medications that treat COPD”. Now, based on the previous semtype search, we find several candidates documents that have promising candidate concepts. Take the following example passage from a medical document: “Levalbuterol is commonly used to treat chronic obstructive pulmonary disease and other breathing problems.”

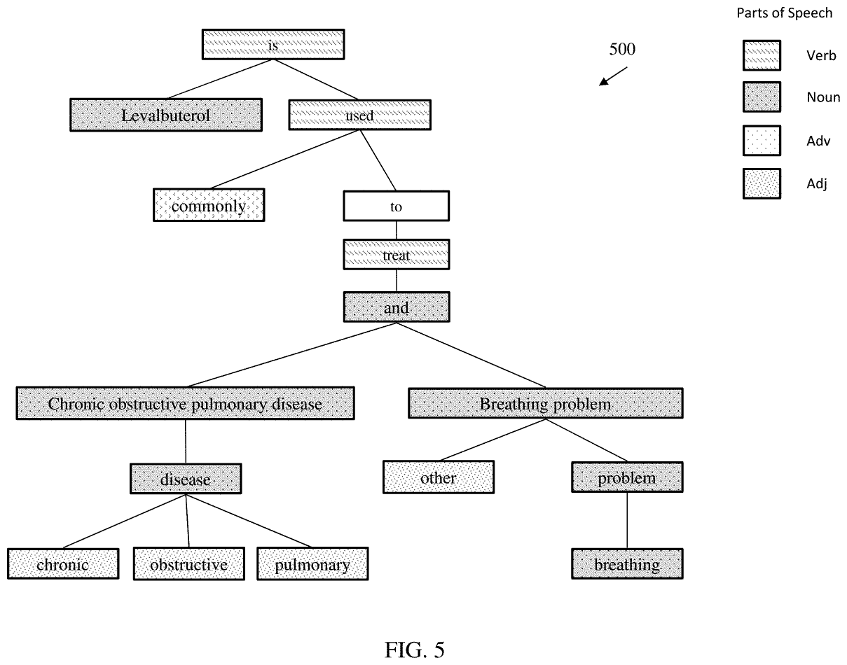

The above passage include candidate concepts for the system 400 to determine the relationship. Utilizing parsing rules, the system 400 can graphically visualize this passage to see if there is a relationship between the candidate medication and the instance of COPD found in the passage. FIG. 5 depicts an exemplary parse tree for the example passage from a document according to one or more embodiments. As shown in the exemplary parse tree 500, the linkage between “Levalbuterol and “chronic obstructive pulmonary disease” has a relatively small distance utilizing a distance metric. Using parse rules or machine learning, the semantic search engine 402 can identify “treats” as the verb that links “Levalbuterol and “chronic obstructive pulmonary disease”. Since “treats” is an exact match, the semantic search engine 402 can have a high confidence level regarding the strength of the linkage based on the parse distance.

In one or more embodiments of the invention, the following new passage can be analyzed utilizing the semantic search engine 402: “Levalbuterol is used to control wheezing and shortness of breath caused by breathing problems (such as asthma, chronic obstructive pulmonary disease)”

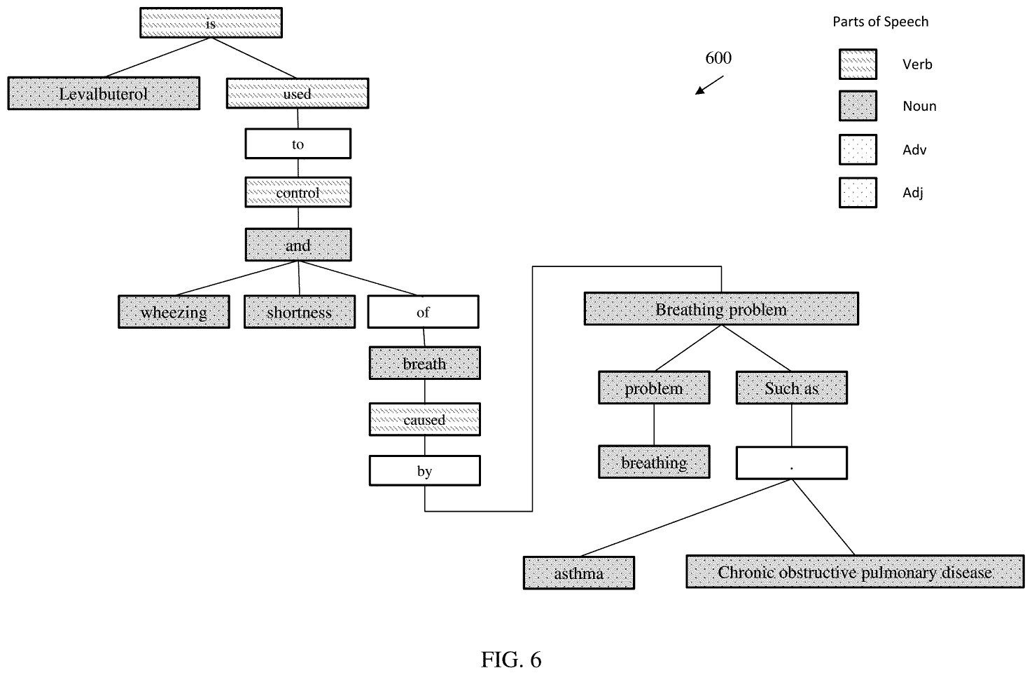

Utilizing parsing rules, the system 400 can graphically visualize this passage to see if there is a relationship between the candidate medication and the instance of COPD found in the passage. FIG. 6 depicts an exemplary parse tree for the example new passage from a document according to one or more embodiments. In this example, the parse tree 600 shows that COPD is secondarily linked to the Levelbuterol. In this example, Levalbuterol treats “wheezing” and “shortness of breath.” This is reflected in the parse tree distance. Again, this confidence metric could be learned as well. Also note that the verb “control” is a reasonable synonym for “treats”, but it is not an exact match, so for both of these reasons, this passage would include a lower confidence level than the first passage. Also, in the parse tree 600, there are multiple verbs along the path between Levalbuterol and COPD. That being said, the concepts have enough distance from one another and also the intervening language would cause the semantic search engine 402 lower the confidence level for the potential relationship of Levalbuteol treating COPD in this example.

In one or more embodiments of the invention, consider the following passage taken from a document: “Levalbuterol is an inhaled beta-2-agonist. It used to control wheezing and shortness of breath caused by breathing problems (such as asthma, chronic obstructive pulmonary disease).” As shown in this passage, there is an anaphora resolution included in the passage which would cause the semantic search engine 402 to lower the confidence level of the relationship between Levalbuterol treating COPD. In this example, the semantic search engine 402 can associate “Levabuterol” with “it” and then associate “it” with “chronic obstructive pulmonary disease.” However, because of this extra level of indirection, the semantic search engine 402 would still lower the confidence level for this particular relationship of treat.

In one or more embodiments of the invention, the semantic search engine 402 can return search results at the search output 410. In one or more embodiments of the invention, the search output 410 can be an online portal for users to receive access to the search results obtained from the searchable corpus 420. In some embodiments, the search output 410 can be any type of graphical user interface (GUI) that allows users to receive and review the results of the semantic search. The semantic search input 404 likewise can be one or more fields in the GUI for a user to input a semantic search query. In some embodiments, the GUI can be configured to present the results of the semantic search as navigable documents or indexes for documents for ease of review by the user. When the semantic search engine 402 identifies the semantic search results, the engine 402 can extract bibliographic information associated with the resulting documents/results. For example, if a doctor is searching medical charts as the searchable corpus 420, the semantic search engine 402 can extract characteristics of the patient associated with the chart and display along with the results. So if a doctor or medical professional is searching for medications to treat a certain condition, the patient information can accompany the results to better assist the medical professional with choosing which result will be more relevant. So if the medical professional is treating a patient with certain other conditions and the medication could have interactions with these other conditions, the medical professional can look at similarly situated patients to see how the treatment plan was enacted in the search results. In one or more embodiments of the invention, the semantic search engine 402, when searching and returning search results from a corpus 420 including medical information for the patient, can remove identifying information about the patients in the search result. This removal of identifying information can keep the patient information confidential as the user would not be able to identify the patient and still have access to the pertinent medical information in the search result document.

In one or more embodiments of the invention, the semantic search engine 402 returns search results based on identified concepts and relationships between the identified concepts in the semantic search query. The search results can include documents that have the same or similar identified relationships between entities in the document. In some embodiments, the relationships can be verified by a user when analyzing the search results. For example, a document may be returned for medications that treat a certain condition. In the search result document, the semantic search engine 402 can provide a visual indicator that draws attention to the reasoning as to why the documents were returned. For example, the search concepts in the semantic search query may be highlighted in the document along with the concept or word that identifies the relationship between the highlighted concepts. In the COPD example, the term “treats” may be highlighted if in the document or other terms that are similar that convey the same relationship such as, for example, prescribed, alleviates, treatment, administered, and the like. The user can see the visual indicators to determine whether the relationship meaning in the user's semantic search query has been properly identified and whether the document will be relevant to the search. In some embodiments, the user can provide feedback to the semantic search engine 402 to allow for better results in future searches.

In one or more embodiments of the invention, the controller 402 can be implemented on the processing system 300 found in FIG. 3. Additionally, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In embodiments of the invention, the engines 402, 406 can also be implemented as so-called classifiers (described in more detail below). In one or more embodiments of the invention, the features of the various engines/classifiers (402, 406) described herein can be implemented on the processing system 300 shown in FIG. 3, or can be implemented on a neural network (not shown). In embodiments of the invention, the features of the engines/classifiers 402, 406 can be implemented by configuring and arranging the processing system 300 to execute machine learning (ML) algorithms. In general, ML algorithms, in effect, extract features from received data (e.g., inputs to the engines 402, 406) in order to “classify” the received data. Examples of suitable classifiers include but are not limited to neural networks (described in greater detail below), support vector machines (SVMs), logistic regression, decision trees, hidden Markov Models (HMMs), etc. The end result of the classifier's operations, i.e., the “classification,” is to predict a class for the data. The ML algorithms apply machine learning techniques to the received data in order to, over time, create/train/update a unique “model.” The learning or training performed by the engines/classifiers 402, 406 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In embodiments of the invention where the engines/classifiers 402, 406 are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network. In the descriptions here, any functionality ascribed to the system 400 can be implemented using the processing system 300 applies.

The NLP engine 406 can perform natural language processing (NLP) analysis techniques on the semantic search input 404 as well as the corpus 420. NLP is utilized to derive meaning from natural language.

The NLP engine 406 can analyze a semantic search query by parsing, syntactical analysis, morphological analysis, and other processes including statistical modeling and statistical analysis. The type of NLP analysis can vary by language and other considerations. The NLP analysis is utilized to generate a first set of NLP structures and/or features which can be utilized by the semantic search engine 402 to identify potential search results from the corpus 420. These NLP structures include a translation and/or interpretation of the natural language input, including synonymous variants thereof. The NLP engine 406 can analyze the features to determine a context for the features. NLP analysis can be utilized to extract attributes (features) from the natural language. These extracted attributes can be analyzed by the semantic search engine 402 to determine one or more search results.

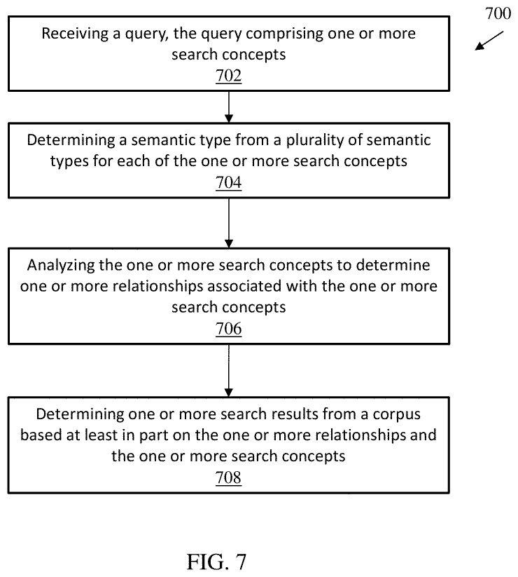

FIG. 7 depicts a flow diagram of a method for semantic searching according to one or more embodiments of the invention. The method 700 includes receiving a query, the query comprising one or more search concepts, as shown in block 702. Also, at block 704, method 700 includes determining a semantic type from a plurality of semantic types for each of the one or more search concepts. Then, the method 700 includes analyzing the one or more search concepts to determine one or more relationships associated with the one or more search concepts, as shown in block 706. And at block 708, the method 700 includes determining one or more search results from a corpus based at least in part on the one or more relationships and the one or more search concepts.

Additional processes may also be included. It should be understood that the processes depicted in FIG. 7 represent illustrations, and that other processes may be added or existing processes may be removed, modified, or rearranged without departing from the scope and spirit of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user' s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for semantic searching, the method comprising:
receiving a query, the query comprising one or more search concepts;
determining a semantic type from a plurality of semantic types for each of the one or more search concepts;
analyzing the one or more search concepts to determine one or more relationships associated with the one or more search concepts; and
determining one or more search results from a corpus based at least in part on the one or more relationships and the one or more search concepts.

2. The computer-implemented method of claim 1, wherein determining the one or more relationships associated with the one or more search concepts comprises:
tokenizing the one or more search concepts; and
determining the one or more relationships based at least in part on a token distance between each search concept in the one or more search concepts.

3. The computer-implemented method of claim 2, wherein determining the one or more relationships based at least in part on a token distance between each search concept in the one or more search concepts comprises:
analyzing the one or more search concepts based on a determination that the token distance is within a threshold token distance.

4. The computer-implemented method of claim 2, wherein determining the one or more relationships based at least in part on a token distance between each search concept in the one or more search concepts comprises:
discarding a first search concept in the one or more search concepts based at least in part on determining that a first token distance associated with the first search concept is above a threshold token distance.

5. The computer-implemented method of claim 1 further comprising:
displaying the one or search results to a user.

6. The computer-implemented method of claim 5, wherein displaying the one or more search results to the user comprises:
providing a visual indicator highlighting one or more concepts in the one or more search results, wherein the one or more concepts are associated with the one or more search concepts.

7. The computer-implemented method of claim 5, wherein the corpus comprises a medical corpus.

8. The computer-implemented method of claim 7, wherein displaying the one or more search results to the user comprises:
removing identifying data associated with the one or more search results, wherein identifying data comprises patient identifying information.

9. The computer-implemented method of claim 1, wherein the corpus comprises a plurality of annotated concepts.

10. The computer-implemented method of claim 1, wherein the corpus does not include relationship annotations.

11. A system for semantic searching comprising:
a processor communicatively coupled to a memory, the processor configured to:
receive a query, the query comprising one or more search concepts;
determine a semantic type from a plurality of semantic types for each of the one or more search concepts;
analyze the one or more search concepts to determine one or more relationships associated with the one or more search concepts;
determine one or more search results from a corpus based at least in part on the one or more relationships and the one or more search concepts.

12. The system of claim 11, wherein determining the one or more relationships associated with the one or more search concepts comprises:
tokenizing the one or more search concepts; and
determining the one or more relationships based at least in part on a token distance between each search concept in the one or more search concepts.

13. The system of claim 12, wherein determining the one or more relationships based at least in part on a token distance between each search concept in the one or more search concepts comprises:
analyzing the one or more search concepts based on a determination that the token distance is within a threshold token distance.

14. The system of claim 12, wherein determining the one or more relationships based at least in part on a token distance between each search concept in the one or more search concepts comprises:
discarding a first search concept in the one or more search concepts based at least in part on determining that a first token distance associated with the first search concept is above a threshold token distance.

15. The system of claim 11, wherein the processor is further configured to display the one or search results to a user.

16. A computer program product for semantic searching comprising a computer readable storage medium having program instructions embodied therewith, the program instructions executable by a processor to cause the processor to perform a method comprising:
receiving a query, the query comprising one or more search concepts;
determining a semantic type from a plurality of semantic types for each of the one or more search concepts;
analyzing the one or more search concepts to determine one or more relationships associated with the one or more search concepts;
determining one or more search results from a corpus based at least in part on the one or more relationships and the one or more search concepts.

17. The computer program product of claim 16, wherein determining the one or more relationships associated with the one or more search concepts comprises:
tokenizing the one or more search concepts; and
determining the one or more relationships based at least in part on a token distance between each search concept in the one or more search concepts.

18. The computer program product of claim 17, wherein determining the one or more relationships based at least in part on a token distance between each search concept in the one or more search concepts comprises:
analyzing the one or more search concepts based on a determination that the token distance is within a threshold token distance.

19. The computer program product of claim 17, wherein determining the one or more relationships based at least in part on a token distance between each search concept in the one or more search concepts comprises:
discarding a first search concept in the one or more search concepts based at least in part on determining that a first token distance associated with the first search concept is above a threshold token distance.

20. The computer program product of claim 16 further comprising:
displaying the one or search results to a user.
